(19) United States
(12) Patent Application Publication
(10) Pub. No.: US 2026/0354622 A1
(43) Pub. Date: Nov. 12, 2026

(54) BARBECUE APPARATUS

(71) Applicant: Yong Tae OM, Gyeonggi-do (KR)

(72) Inventor: Yong Tae OM, Gyeonggi-do (KR)

(21) Appl. No.: 19/671,426

(22) Filed: May 8, 2026

(30) Foreign Application Priority Data
May 8, 2025 (KR) 10-2025-0059843

(51) Int. Cl. A47J 37/07

(52) U.S. Cl. CPC A47J 37/0786; A47J 2037/0795

(57) ABSTRACT

A barbecue apparatus includes a main body having a combustion chamber on one side of an inside thereof and a heat transfer passage formed from the combustion chamber toward an exhaust port provided on the other side outside the combustion chamber, a heat source provision module provided in the combustion chamber to provide a heat source to grill an object to be grilled, a grill holder located within a grill chamber provided on the other side of the inside of the main body, and provided to allow a grill placed thereon, and a height adjustment unit located on both sides of the grill chamber to adjust a height of the grill holder, configured to move up and down along longitudinal guides by rotation of a rotating shaft, by link connection.

### BACKGROUND

The present invention relates to a barbecue apparatus, and more particularly to a barbecue apparatus that grills an object to be grilled, such as meat, using a heat source.

In general, food-related establishments, such as restaurants, prepare grilled meat dishes by igniting a combustible material, such as charcoal or firewood, to grill meat, placing a grill above the combustible material, and then cooking pork, beef, duck, etc. placed on the grill using the heat of the flames generated due to combustion of the combustible material.

This method offers the advantage of a short grilling time because the surface of the meat comes into direct contact with the heat of the flames generated due to combustion of the combustible material, but oil, meat scraps, etc. generated as the meat cooks fall onto the combustible material, such as charcoal or firewood, thereby causing severe smoke or flames, and thus often causing discomfort to consumers during the grilling process.

To solve the above discomfort, technology related to barbecue equipment was proposed in Korean Patent Registration No. 1985539 (Patent Document 1).

However, Patent Document 1 had the disadvantage of not being able to adjust the position of a grill, thereby making it difficult to efficiently grill meat.

PATENT DOCUMENT: Korean Patent Registration No. 1985539 (Registration Date: May 28, 2019)

### SUMMARY OF THE INVENTION

Therefore, the present invention has been made in view of the above problems, and it is an object of the present invention to provide a barbecue apparatus in which the height of a grill is adjustable in stages while grilling an object to be grilled using indirect heat from a heat source.

In accordance with an aspect of the present invention, the above and other objects may be accomplished by the provision of a barbecue apparatus including a main body having a combustion chamber on one side of an inside thereof and a heat transfer passage formed from the combustion chamber toward an exhaust port provided on the other side outside the combustion chamber, a heat source provision module provided in the combustion chamber to provide a heat source to grill an object to be grilled, a grill holder located within a grill chamber provided on the other side of the inside of the main body, and provided to allow a grill placed thereon, and a height adjustment unit located on both sides of the grill chamber to adjust a height of the grill holder, configured to move up and down along longitudinal guides by rotation of a rotating shaft, by link connection.

The heat source provision module may provide the heat source through charcoal accommodated in a charcoal accommodation unit detachably attached to the combustion chamber in a sliding manner, provide the heat source by firewood after separating the charcoal accommodation unit from the combustion chamber, or provide the heat source by an electric coil within the heat transfer passage.

The barbecue apparatus may further include a rotation angle adjustment unit provided on one end of the rotating shaft, to which the height adjustment unit is connected, to adjust a rotation angle of the rotating shaft.

The rotation angle adjustment unit may include a locking guide fixed to an outer wall of the main body, through which the rotating shaft passes, and having recesses formed at set intervals along a lower arc surface and located on the same radius about the rotating shaft, and a locking lever including a case coupled to the rotating shaft to be moved in conjunction with the rotating shaft, and a fastening bar configured to protrude from an inside of the case by a set distance by an elastic body and provided with a catch at one end of the fastening bar, so that the catch is engaged with one of the recesses in a pressed state.

A blowtorch coupling member may be detachably attached to a lower portion of an inside of the charcoal accommodation unit or the combustion chamber to couple a blowtorch thereto.

The barbecue apparatus may further include a mesh body above the grill holder to transfer the heat moving through the heat transfer passage.

The height adjustment unit may further include guides located in a longitudinal direction to guide connection members connected to both ends of the grill holder to move vertically, first links, each having one end fixed to an outer end of a corresponding one of the guides, second links, each having one end fixed to the other end of a corresponding one of the first links to form a set angle therebetween, and third links, each having one end fixed to the other end of a corresponding one of the second links to rotate, and the other end fixed to the rotating shaft.

An opening and closing cover provided above the main body may be opened and closed in a hinged manner.

Rings provided at one side of the main body and configured to rotate may be engaged with or released from an engagement shaft provided in one end of the opening and closing cover, a second shaft provided in the other end of the opening and closing cover and a first shaft provided at the other side of the main body may be connected by connection bars so that the opening and closing cover is rotatable, both ends of an opening force provider formed in a cylindrical structure may be rotatably connected to a side of the connecting bar in a direction of the connection bars and a lower portion of the main body, and a protrudable upper end of the opening force provider may be elastically supported.

In accordance with another aspect of the present invention, there is provided a barbecue apparatus including a main body having a combustion chamber on one side of an inside thereof and a heat transfer passage formed from the combustion chamber toward an exhaust port provided on the other side outside the combustion chamber, a heat source provision module provided in the combustion chamber to provide a heat source to grill an object to be grilled, a grill holder located within a grill chamber provided on the other side of the inside of the main body, and provided to allow a grill placed thereon, a height adjustment unit located on both sides of the grill chamber to adjust a height of the grill holder, configured to move up and down along longitudinal guides by rotation of a rotating shaft, by link connection, and a rotation angle adjustment unit provided on one end of the rotating shaft, to which the height adjustment unit is connected, to adjust a rotation angle of the rotating shaft, wherein the rotation angle adjustment unit includes a locking guide fixed to an outer wall of the main body, through which the rotating shaft passes, and having recesses formed at set intervals along a lower arc surface and located on the same radius about the rotating shaft, and a locking lever including a case coupled to the rotating shaft to be moved in conjunction with the rotating shaft, and a fastening bar configured to protrude from an inside of the case by a set distance by an elastic body and provided with a catch at one end of the fastening bar, so that the catch is engaged with one of the recesses in a pressed state, and the heat transfer passage is formed in an upper portion of the main body configured to connect the combustion chamber and the exhaust port, so that heat from the heat source moving along the heat transfer passage is transferred to the object to be grilled placed on the grill holder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a barbecue apparatus according to a first embodiment of the present invention, illustrating a state in which a cover is opened;

FIG. 2 is a cross-sectional view of the barbecue apparatus according to the first embodiment of the present invention, illustrating a state in which a charcoal accommodation unit is provided to allow charcoal to be used as a heat source provision module;

FIG. 3 is a cross-sectional view of the charcoal accommodation unit of the barbecue apparatus according to the first embodiment of the present invention;

FIG. 4A and FIG. 4B are side views of the barbecue apparatus according to the first embodiment of the present invention, illustrating a state in which the height of a grill holder is adjusted by a height adjustment unit;

FIG. 5 is a side view of the barbecue apparatus according to the first embodiment of the present invention before and after operation of a rotation angle adjustment unit;

FIG. 6 is a cross-sectional view of a locking lever of the barbecue apparatus according to the first embodiment of the present invention;

FIG. 7 is a cross-sectional view of the barbecue apparatus according to the first embodiment of the present invention, illustrating a state in which firewood is used as the heat source provision module;

FIG. 8 is a cross-sectional view of the barbecue apparatus according to the present invention, illustrating a state in which an electric coil is used as the heat source provision module; and

FIG. 9 and FIG. 10 are cross-sectional views of a barbecue apparatus according to a second embodiment of the present invention before and after opening and closing a cover.

### DETAILED DESCRIPTION OF THE INVENTION

The above-described objects, features, and other advantages of the present invention will become more apparent by describing exemplary embodiments of the present invention in detail with reference to the accompanying drawings. Hereinafter, a barbecue apparatus according to embodiments of the present invention will be described in detail with reference to the accompanying drawings.

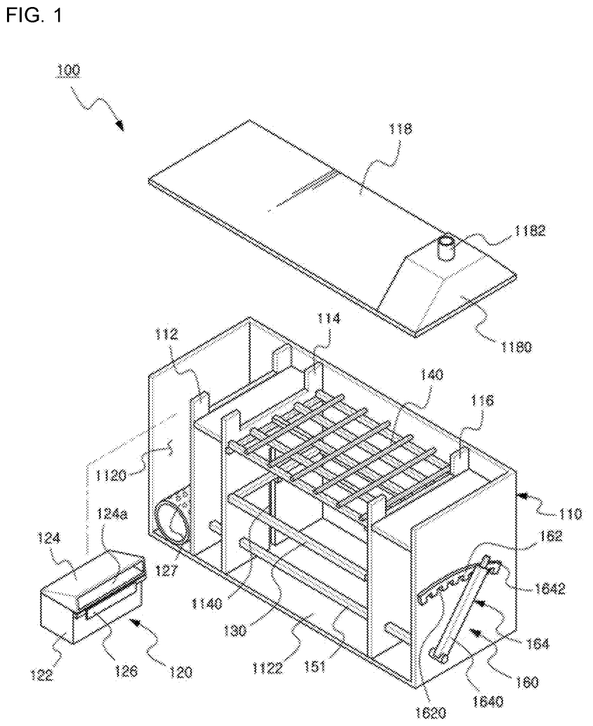

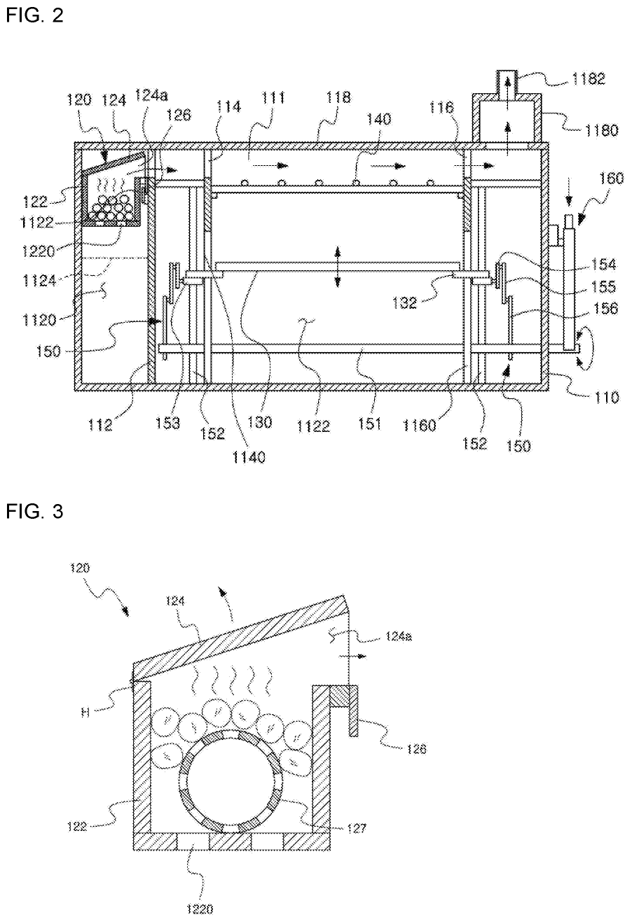

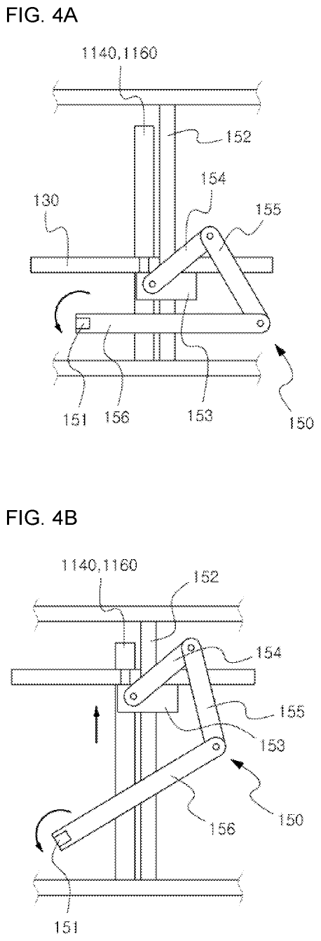

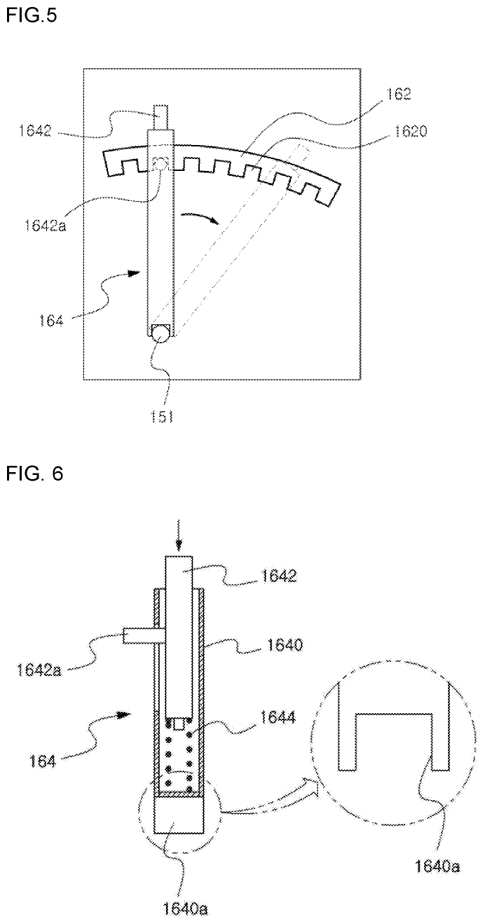

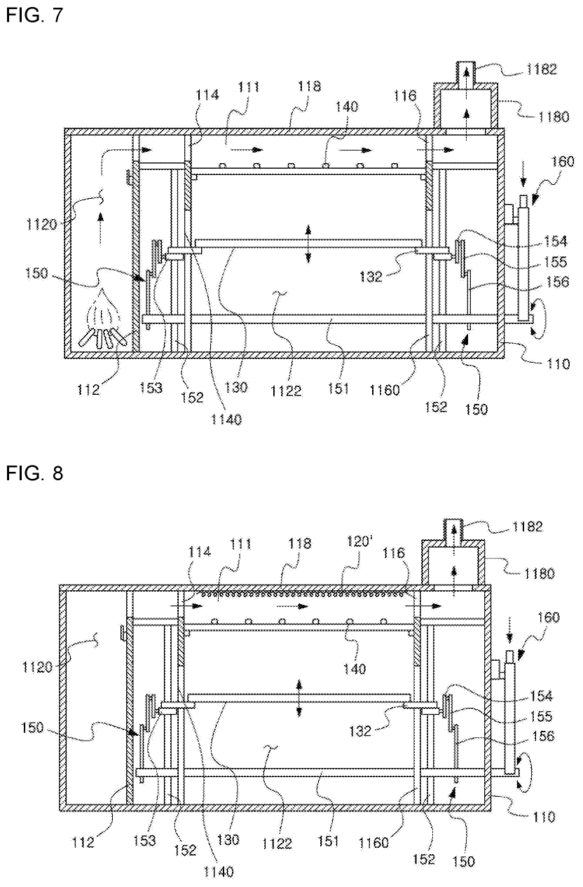

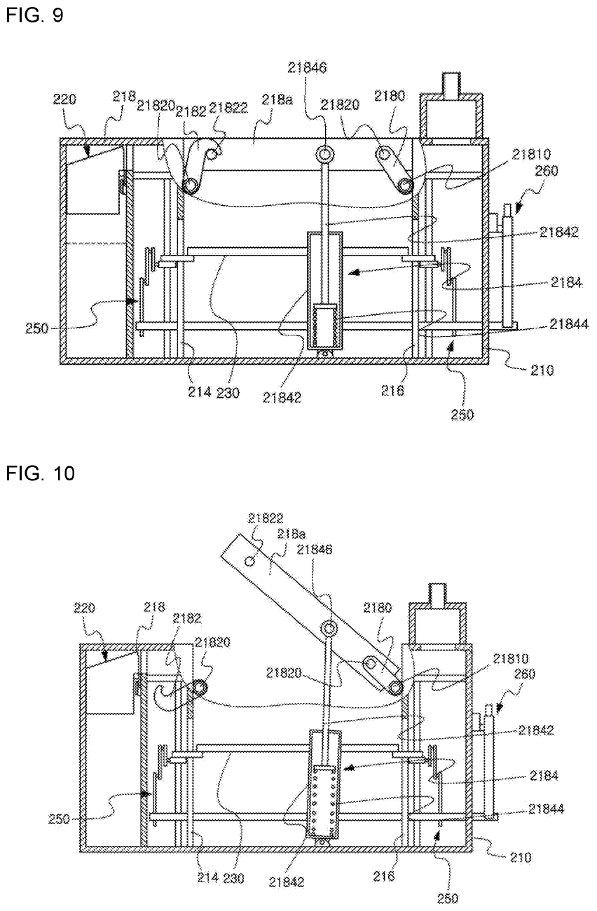

FIG. 1 is an exploded perspective view of a barbecue apparatus according to a first embodiment of the present invention, illustrating a state in which a cover is opened, FIG. 2 is a cross-sectional view of the barbecue apparatus according to the first embodiment of the present invention, illustrating a state in which a charcoal accommodation unit is provided to allow charcoal to be used as a heat source provision module, FIG. 3 is a cross-sectional view of the charcoal accommodation unit of the barbecue apparatus according to the first embodiment of the present invention, FIG. 4a and FIG. 4b are side views of the barbecue apparatus according to the first embodiment of the present invention, illustrating a state in which the height of a grill holder is adjusted by a height adjustment unit, FIG. 5 is a side view of the barbecue apparatus according to the first embodiment of the present invention before and after operation of a rotation angle adjustment unit, FIG. 6 is a cross-sectional view of a locking lever of the barbecue apparatus according to the first embodiment of the present invention, FIG. 7 is a cross-sectional view of the barbecue apparatus according to the first embodiment of the present invention, illustrating a state in which firewood is used as the heat source provision module, FIG. 8 is a cross-sectional view of the barbecue apparatus according to the present invention, illustrating a state in which an electric coil is used as the heat source provision module, and FIG. 9 and FIG. 10 are cross-sectional views of a barbecue apparatus according to a second embodiment of the present invention before and after opening and closing a cover.

Referring to FIG. 1 to FIG. 8, a barbecue apparatus 100 according to a first embodiment of the present invention includes a main body 110, a charcoal accommodation unit 120, a grill holder 130, a mesh body 140, a height adjustment unit 150, and a rotation angle adjustment unit 160, and the barbecue apparatus 100 is installed outdoors, etc., to grill an object to be grilled, which is placed on a grill, while heat from a heat source moves from a combustion chamber 1120 to an exhaust port 1182.

As shown in FIG. 1 and FIG. 2, the main body 110 is formed in a hexahedral shape with a space formed therein, a first partition wall 112 and a second partition wall 114 spaced apart from each other are sequentially formed in the main body 110 to be spaced apart from one side wall (the left side wall of FIG. 2), a third partition wall 116 is formed in the main body 110 to be spaced apart from the other side wall (the right side of FIG. 2), and a cover 118 is provided above the main body 110.

Here, the main body 110 has the combustion chamber 1120 formed between one side wall and the first partition wall 112, and a grill chamber 1122 formed between the second partition wall 114 and the third partition wall 116.

Further, although not shown in the drawings, an opening and closing door may be provided at an entrance of the grill chamber 1122.

Openings are formed in the upper portions of the first partition wall 112, second partition wall 114, and third partition wall 116 and are integrally connected to form a heat transfer passage 111 through which heat from the heat source may move. The heat transfer passage 111 connects the combustion chamber 1120, the grill chamber 1122, and a collection port 1180 formed on the other side of the cover 118.

Furthermore, a front cover 1124 is provided on the upper portion of the main body 110 between one side wall of the main body 110 and the first partition wall 112 so that the upper end of the front cover 1124 is opened and closed by a hinge, thereby blocking heat from the charcoal accommodation unit 120 provided in the upper portion of the combustion chamber 1120.

The collection port 1180 formed on the other side of the cover 118 is vertically connected to one end of the horizontally formed heat transfer passage 111. The exhaust port 1182 is formed in the collection port 1180, and an exhaust fan (not shown) is installed in the collection port 1180 to forcibly exhaust heat from the heat source located within the combustion chamber 1120 to the exhaust port 1182 via the heat transfer passage 111.

The charcoal accommodation unit 120, as shown in FIG. 1 to FIG. 3, is a type of heat source provision module that is provided in the upper portion of the combustion chamber 1120 and provides the heat source to grill the object to be grilled.

That is, the charcoal accommodation unit 120 accommodates charcoal therein, and may be attached to or detached from the combustion chamber 1120 in a sliding manner in an ignition state.

Here, the charcoal accommodation unit 120 includes a lower body 122 and an upper cover 124.

The lower body 122 accommodates charcoal therein, and has a plurality of holes 1120 formed through the bottom surface of the lower body 122, and a first hook 126 provided in the transverse direction on the inner surface of the lower body 122 so as to be slidably moved after being hooked to a second hook 1122 provided on the first partition 112.

The upper cover 124 is connected to the end of the lower body 122 by a hinge H and may thus rotate to accommodate or replace charcoal, and the upper cover 124 is disposed to be inclined so as to guide the heat of the charcoal so that the heat may move along the inclined surface of the upper cover 124 to the heat transfer passage 111 through a transverse discharge port 124a of the lower body 122.

Furthermore, a blowtorch coupling member 127 formed in a transverse tubular shape may be attached to and detached from the charcoal accommodation unit 120 so as to allow a blowtorch to be attached to the lower portion of the inside of the blowtorch coupling member 127. That is, in a state in which the blowtorch is connected to one end of the blowtorch coupling member 127, the charcoal placed above the blowtorch coupling member 127 may be ignited by flames from the blowtorch.

In addition, referring to FIG. 7, after the charcoal accommodation unit 120 has been separated from the upper portion of the combustion chamber 1120, firewood located on the bottom of the combustion chamber 1120 may be used as a heat source provision module.

At this time, when the charcoal accommodation unit 120 is separated from the combustion chamber 1120 and firewood is provided as a heat source, the blowtorch coupling member 127 may be coupled to the lower portion of the combustion chamber 1120 (see FIG. 1).

Further, referring to FIG. 8, after the charcoal accommodation unit 120 has been separated from the upper portion of the combustion chamber 1120, an electric coil 120′ provided in the heat transfer passage 111 may be used as the heat source provision module configured to provide a heat source.

As shown in FIG. 1, FIG. 2, FIG. 4a and FIG. 4b, the grill holder 130 is located within the grill chamber 1122 of the main body 110 to allow a grill to be placed thereon to grill an object to be grilled, and the height of the grill holder 130 is adjusted by the height adjustment unit 150.

At this time, the grill holder 130 is provided in a square frame structure, and extension members 132 extend from the centers of both ends of the grill holder 130.

As shown in FIG. 1 and FIG. 2, the mesh body 140 is fixedly located on the grill holder 130, and the heat moving along the heat transfer passage 111 is transferred to the object to be grilled placed on the grill holder 130 below.

The height adjustment unit 150 is located on both sides of the grill chamber 1122, i.e., between the first partition wall 112 and the second partition wall 114 and between the third partition wall 116 and the right wall of the main body 110, as shown in FIGS. 1, 2, and 4 to 6, to adjust the height of the grill holder 130 by link connection due to rotation of a rotating shaft 151, and the height adjustment unit 150 includes the rotating shaft 151, guides 152, the connection members 153, first links 154, second links 155, and third links 156.

The rotating shaft 151 is provided in the transverse direction through the second partition wall 114, the third partition wall 116, and the right wall of the main body 110. Here, the rotating shaft 151 is provided to have a polygonal cross-section, and in this embodiment, the rotating shaft 151 is exemplified as having a square cross-section.

The guides 152 are installed in the longitudinal direction between the first partition wall 112 and the second partition wall 114 and between the third partition wall 116 and the right wall of the main body 110.

Furthermore, the guides 152 guide the movement direction of connection members 153 to which the extension members 132 of the grille holder 130 are fixed.

The connection members 153 move up and down in a state in which each of the connection members 153 is connected to a corresponding one of the guides 152.

One end of each of the first links 154 is fixed to the outer surface of a corresponding one of the connection members 153, respectively.

One end of each of the second links 155 is fixed to the other end of a corresponding one of the first links 154 to form a set angle therebetween.

One end of each of the third links 156 is fixed to the other end of a corresponding one of the second links 155 to rotate, and the other end of each of the third links 156 is fixed to the rotating shaft 151.

The rotation angle adjustment unit 160 is provided at one end of the rotating shaft 151 that penetrates the right wall of the main body 110 to adjust the rotation angle of the rotating shaft 151, and the rotation angle adjustment unit 160 includes a locking guide 162 and a locking lever 164.

The locking guide 162 has an arc surface formed on the lower portion of the right wall of the main body 110, through which the rotating shaft 151 penetrates, to correspond to a radial direction centered on the rotating shaft 151, and recesses 1620 are formed at set intervals in the lower arc surface.

The locking lever 164 is rotated about the rotating shaft 151, and is engaged with any one of the recesses 1620 of the locking guide 162 to lock or unlock the height adjustment unit 150, and the locking lever 164 includes a case 1640, a fastening bar 1642, and an elastic body 1644.

The case 1640 is formed in a hollow structure, and a recess 1640a corresponding to the cross-section of the rotating shaft 151 is formed in the bottom of the case 1640 to be coupled to the rotating shaft 151, thereby linked with rotation of the rotating shaft 151.

The fastening bar 1642 is configured such that the upper end thereof protrudes and the fastening bar 1642 moves back and forth within the case 1640, and a catch 1642a protrudes from the upper portion of the fastening bar 1642 and is engaged with one of the recesses 1620 of the locking guide 162 so as to prevent the rotating shaft 151 from rotating.

The elastic body 1644 is a spring that is located between the lower portion of the fastening bar 1642 and the lower portion of the case 1640, and provides elasticity to be compressed when the fastening bar 1642 is pressed and to be raised to an original position when the pressure applied to the fastening bar 1642 is released.

The operation process of the above-described barbecue apparatus 100 according to the present invention will be described as follows.

First, the grill on which an object to be grilled is placed is placed on the grill holder 130.

Next, the charcoal accommodation unit 120 in which charcoal before ignition or ignited charcoal is accommodated is slidably loaded onto the upper portion of the combustion chamber 1120. At this time, if the charcoal before ignition is placed in the charcoal accommodation unit 120, the charcoal may be ignited by gas connected to the blowtorch in a state in which the blowtorch is coupled to the blowtorch coupling member 127 provided in the lower portion of the inside of the ignition chamber 1120.

In contrast, if firewood located in the lower portion of the combustion chamber 1120 is used in a state in which the charcoal accommodation unit 120 is removed, the firewood may be ignited by gas connected to the blowtorch in the state in which the blowtorch is coupled to the blowtorch coupling member 127 provided in the lower portion of the inside of the ignition chamber 1120.

Next, through a process of forcibly collecting heat from charcoal, or the like from the combustion chamber 1120 through the heat transfer passage 111 provided in the horizontal direction to the collection port 1180 provided in the vertical direction and then forcibly exhausting the heat through the exhaust port 1182, indirect heat is transferred to the object to be grilled placed on the grill through the mesh body 140 so that the object to be grilled is grilled by the indirect heat.

At this time, if the object to be grilled is too close to the heat transfer passage 111 and thus overcooked, or if the object to be grilled is too far away from the heat transfer passage 111 and thus undercooked, the height of the grill holder 130 is adjusted.

That is, when the fastening bar 1642 of the locking lever 164 is pressed, the fastening bar 1642 descends, and the catch 1642a provided on the fastening bar 1642, which has been engaged with one of the recesses 1620 of the locking guide 162, is disengaged from the recess 1620 of the locking guide 162. In this state, when the locking lever 164 is rotated in one direction, the locking lever 164 rotates the rotating shaft 151 by the recess 1640a formed in the bottom of the case 1640.

Then, when the rotating shaft 151 rotates, the third links 156 rotate in conjunction with rotation of the rotating shaft 151, move the second links 155 and the first links 154 with a fixed angle therebetween upward or downward, and move the extension members 132 of the grill holder 130, to which the first links 154 are fixed, in conjunction with movement of the first links 154 and the second links 155, so that the extension members 132 move upward or downward along the guides 152.

Then, when the height of the grill holder 130 fixed to the extension members 132 is adjusted and the height of the grill holder 130 is set, pressure applied to the fastening bar 1642 of the locking lever 164 is released, the fastening bar 1642 rises due to the elastic force of the elastic body 1644, the catch 1642a provided on the fastening bar 1642, which has been separated from the recesses 1620 of the locking guide 162, is engaged with one of the recesses 1620, and thus, the position of the grill holder 130 is fixed.

Referring to FIG. 9 and FIG. 10, a barbecue apparatus 200 according to a second embodiment of the present invention includes a main body 210, a charcoal accommodation unit 220, a grill holder 230, a mesh body 240, a height adjustment unit 250, and a rotation angle adjustment unit 260. The remaining structures and functions of the barbecue apparatus 200 according to the second embodiment may be the same as those of the barbecue apparatus 100 according to the first embodiment, except that the main body 210, particularly the cover 218, is opened and closed.

As shown in FIG. 9 and FIG. 10, the main body 210 is formed in a hexahedral shape with a space formed therein, as in the first embodiment, a first partition wall 212 and a second partition wall 214 spaced apart from each other are sequentially formed in the main body 210 to be spaced apart from one side wall (the left side wall of FIG. 9), a third partition wall 216 is formed in the main body 210 to be spaced apart from the other side wall (the right side of FIG. 2), and the cover 218 is provided on the top of the main body 310.

The cover 218 has a cut portion formed to have a length corresponding to a distance between the second partition wall 214 and the third partition wall 216, and an opening and closing cover 218a is provided in the cut portion so as to be opened and closed by connection bars 2180, rings 2182, and an opening force provider 2184.

Here, a first shaft 21810 in the transverse direction is provided to be rotatably supported on the upper portion of the inner wall of the third partition wall 216, and a second shaft 21820 in the transverse direction is provided to be supported in the other side of the opening and closing cover 218a in the direction of the third partition wall 216 so as to become the starting point of the rotation of the opening and closing cover 218a, and one end of each of the connection bars 2180 is rotatably connected to a corresponding one of both ends of the first shaft 21810, and the other end of each of the connection bars 2180 is rotatably connected to a corresponding one of both ends of the second shaft 21830.

In this way, the other end of the opening and closing cover 218a may be spaced apart from or in contact with the third partition wall 216 by the first shaft 21810 and the connection bars 2180, and be rotated by the second shaft 21830 and the connection bars 2180.

Further, the opening and closing cover 218a has a step formed to extend slightly from one side of the upper surface thereof, so that the step may be caught in the cut portion of the cover 218 when closed.

In addition, at one side of the opening and closing cover 218a, a third shaft 21820 in the transverse direction is provided to be rotatably supported on the upper portion of the inner surface of the second partition wall 214, the rings 2182 are rotatably provided on both ends of the third shaft 21820, an engagement shaft 21822 in the transverse direction is supported in one side of the opening and closing cover 218a in the direction of the second partition wall 214, and the rings 2182 are coupled to or separated from both ends of the engagement shaft 21822. Here, when the opening and closing cover 218a is closed, a forward and backward moving body 21842 of the opening force provider 2184 descends and compresses a spring 21844 in an extended state, and the rings 2182 are caught on the engagement shaft 21822 so as to maintain the compressed state of the spring 21844.

The opening force provider 2184 functions as a shock absorber, and is provided with the forward and backward moving body 21842 that moves back and forth along the inside of a body 21840 rotatably fixed to the bottom surface of the main body 210 and is rotatably supported by a fourth shaft 21846 provided in the direction of the second shaft 21830 in the opening and closing cover 218a, and the spring 21844 provided between the inner surface of the bottom of the body 21840 and the lower portion of the forward and backward moving body 21842 corresponding thereto.

In this way, when the opening and closing cover 218a is rotated upward for opening, the forward and backward moving body 21842 of the opening force provider 2184 rises due to the restoring force of the spring 21844 in the compressed state, and thus allows the opening and closing cover 218a to be opened with little force, and when the opening and closing cover 218a is rotated downward for closing, the forward and backward moving body 21842 of the opening force provider 2184 lowers due to pressure applied to the spring 21844 in the extended state, and thus allows the opening and closing cover 218a to be closed.

Further, one end of the bottom surface of the side of the opening and closing cover 218a in the direction of the second shaft 21830 may be rounded so as not to interfere with the cut portion of the cover 218 when opening and closing, and a foldable soft cover may be attached to a portion of the opening and closing cover 218a adjacent to the cut portion of the cover 218 to prevent smoke from leaking.

As is apparent from the above description, in a barbecue apparatus according to the present invention, when a heat source is provided from at least one of charcoal, firewood, or an electric coil in a combustion chamber in a state in which a grill on which an object to be grilled is placed is placed on a grill holder, heat from the heat source moves from the combustion chamber along an exhaust port so that the object to be grilled is grilled by indirect heat, to prevent oil, meat scraps, etc. from being burned, the height of the grill holder may be adjusted by a height adjustment unit that is locked or unlocked to grill the object to be grilled in an optimal state, and since the upper portion of a main body may be opened and closed by an opening and closing cover, when the object to be grilled has been fully cooked, the object is taken out by opening the opening and closing cover, so that there is an effect of convenient use.

The components included in the various embodiments described above may also be implemented in embodiments of various other possible combinations of modifications not described above, as long as the combinations are not clearly mutually exclusive in terms of implementation.

In addition, the various individual components described above may also be implemented in various other combinations not described above, as long as they are not technically incompatible with each other, and implementation of such combinations should also be construed as falling within the scope of the present invention.

What is claimed is:

1. A barbecue apparatus comprising:
a main body having a combustion chamber on one side of an inside thereof and a heat transfer passage formed from the combustion chamber toward an exhaust port provided on the other side outside the combustion chamber;
a heat source provision module provided in the combustion chamber to provide a heat source to grill an object to be grilled;
a grill holder located within a grill chamber provided on the other side of the inside of the main body, and provided to allow a grill placed thereon;
a height adjustment unit located on both sides of the grill chamber to adjust a height of the grill holder, configured to move up and down along longitudinal guides by rotation of a rotating shaft, by link connection; and
a rotation angle adjustment unit provided on one end of the rotating shaft, to which the height adjustment unit is connected, to adjust a rotation angle of the rotating shaft, wherein the rotation angle adjustment unit comprises:
a locking guide fixed to an outer wall of the main body, through which the rotating shaft passes, and having recesses formed at set intervals along a lower arc surface and located on the same radius about the rotating shaft; and
a locking lever comprising a case coupled to the rotating shaft to be moved in conjunction with the rotating shaft, and a fastening bar configured to protrude from an inside of the case by a set distance by an elastic body and provided with a catch at one end of the fastening bar, so that the catch is engaged with one of the recesses in a pressed state; and
the heat transfer passage is formed in an upper portion of the main body configured to connect the combustion chamber and the exhaust port, so that heat from the heat source moving along the heat transfer passage is transferred to the object to be grilled placed on the grill holder.

2. The barbecue apparatus according to claim 1, wherein the heat source provision module provides the heat source through charcoal accommodated in a charcoal accommodation unit detachably attached to the combustion chamber in a sliding manner, provides the heat source by firewood after separating the charcoal accommodation unit from the combustion chamber, or provides the heat source by an electric coil within the heat transfer passage.

3. The barbecue apparatus according to claim 2, wherein a blowtorch coupling member is detachably attached to a lower portion of an inside of the charcoal accommodation unit or the combustion chamber to couple a blowtorch thereto.

4. The barbecue apparatus according to claim 1, further comprising a mesh body above the grill holder to transfer the heat moving through the heat transfer passage.

5. The barbecue apparatus according to claim 1, wherein the height adjustment unit comprises:
guides located in a longitudinal direction to guide connection members connected to both ends of the grill holder to move vertically;
first links, each having one end fixed to an outer end of a corresponding one of the guides;
second links, each having one end fixed to the other end of a corresponding one of the first links to form a set angle therebetween; and
third links, each having one end fixed to the other end of a corresponding one of the second links to rotate, and the other end fixed to the rotating shaft.

6. The barbecue apparatus according to claim 1, wherein an opening and closing cover provided above the main body is opened and closed in a hinged manner.

7. The barbecue apparatus according to claim 6, wherein rings provided at one side of the main body and configured to rotate are engaged with or released from an engagement shaft provided in one end of the opening and closing cover, a second shaft provided in the other end of the opening and closing cover and a first shaft provided at the other side of the main body are connected by connection bars so that the opening and closing cover is rotatable, both ends of an opening force provider formed in a cylindrical structure are rotatably connected to a side of the connecting bar in a direction of the connection bars and a lower portion of the main body, and a protrudable upper end of the opening force provider is elastically supported.
